(19) United States
(12) Patent Application Publication
(10) Pub. No.: US 2010/0245795 A1
(43) Pub. Date: Sep. 30, 2010

(54) INTERMEDIATE VACUUM SEAL ASSEMBLY FOR SEALING A CHAMBER HOUSING TO A WORKPIECE

(76) Inventors: Fardad A. Hashemi, Moraga, CA (US); Hiroshi Shirasu, Yokohama (JP); Douglas C. Watson, Campbell, CA (US)

Correspondence Address: Roeder & Broder LLP, 5560 Chelsea Avenue, La Jolla, CA, 92037, US

(21) Appl. No.: 12/721,493

(22) Filed: Mar. 10, 2010

Related U.S. Application Data
(60) Provisional application No. 61/163,567, filed on Mar. 26, 2009.

(51) Int. Cl. G03B 27/54; H01J 9/00

(52) U.S. Cl. 355/67; 445/60

(57) ABSTRACT

A chamber assembly (226) for providing a sealed chamber (38) adjacent to a workpiece (28) includes a chamber housing (244), a chamber pressure source (246) and a seal assembly (250). The chamber housing (244) cooperates with the workpiece (28) to define at least a portion of the sealed chamber (38). The chamber pressure source (246) controls a chamber pressure within the sealed chamber (38) to be different than the environmental pressure. The seal assembly (250) seals the chamber housing (244) to the workpiece (28). The seal assembly (250) can include a first seal contact region (270) and a second seal contact region (272) that cooperate to define a seal gap (274) adjacent to at least one of the chamber housing (244) and the workpiece (28). The seal assembly (250) may further include a seal pressure source (276) for controlling a seal pressure within the seal gap (274) so that the seal pressure is different than the chamber pressure and the environmental pressure. The first seal contact region (270) and the second seal contact region (272) cooperate to exert a first force (284) on a surface (278). The seal pressure source (276) generates a second force (286) on the surface (278). The first force (284) is approximately equal in magnitude and opposite in direction to the second force (286).

### RELATED APPLICATION

This application claims priority on U.S. Provisional Application Ser. No. 61/163,567 filed on Mar. 26, 2009 and entitled “Intermediate Vacuum Seal”. As far as is permitted, the contents of U.S. Provisional Application Ser. No. 61/163,567 are incorporated herein by reference.

### BACKGROUND

Exposure apparatuses are commonly used to transfer images from a reticle onto a substrate during the manufacturing and processing of liquid crystal displays (“LCDs”) and semiconductor wafers. There is a never ending desire to manufacture larger LCDs. Typically, larger reticles are required to manufacture larger LCDs. Unfortunately, as the size of the reticles utilized increases, so does the likelihood that the reticle may be subject to a certain amount of sagging due to gravity in the middle region of the reticle that is not directly supported. Accordingly, there is a need to develop a system whereby the potential sagging of the reticle is minimized while inhibiting unwanted distortion of the reticle.

### SUMMARY

The present invention is directed to a chamber assembly for providing a sealed chamber adjacent to a workpiece, e.g. a reticle. The chamber assembly is substantially surrounded by an environment having an environmental pressure. In certain embodiments, the chamber assembly comprises a chamber housing, a chamber pressure source, and a seal assembly. The chamber housing cooperates with the workpiece to define at least a portion of the sealed chamber. The chamber pressure source controls a chamber pressure within the sealed chamber so that the chamber pressure is different than the environmental pressure. The seal assembly seals the chamber housing to the workpiece. With this design, the chamber pressure can be precisely controlled to inhibit sagging of the workpiece.

As an overview, in certain embodiments, the seal assembly is uniquely designed to provide a reliable seal between the chamber assembly and the workpiece without applying a large preload force on the workpiece. This reduces the likelihood of the seal assembly distorting the workpiece.

In some embodiments, the seal assembly includes a first seal contact region and a second seal contact region that cooperate to define a seal gap adjacent to at least one of the chamber housing and the workpiece. The seal contact regions can be made from a resilient material. In one such embodiment, the seal assembly includes an O-ring. In other embodiments, the seal contact region can include or be formed from a foam gasket, an elastomer gasket, a hard material gasket, or a hard material sharp edge that partially penetrates and deforms the work piece.

The seal assembly can include a seal pressure source that controls a seal pressure within the seal gap so that the seal pressure is different than the chamber pressure and the environmental pressure. For example, the seal pressure source can control the seal pressure to be less than the chamber pressure and the environmental pressure. With this design, the seal assembly can seal the sealed chamber between the chamber assembly and the workpiece without the necessity of a large preload force on the workpiece.

In certain embodiments, the chamber pressure source controls the chamber pressure to be less than the environmental pressure. In one such embodiment, the chamber pressure source controls the chamber pressure to be less than the environmental pressure by between approximately 200 and 600 Pascals. As a result thereof, the chamber pressure can be controlled so that the difference between the chamber pressure and the environmental pressure is sufficient to counteract the influence of gravity on the workpiece.

In some embodiments, the first seal contact region is spaced apart from the second seal contact region. In such embodiments, the seal gap is positioned substantially between the first seal contact region and the second seal contact region. In one such embodiment, the first seal contact region substantially encircles the second seal contact region.

In certain embodiments, the workpiece includes a workpiece surface and the chamber housing includes a cover surface. In such embodiments, the seal assembly is positioned substantially between the workpiece surface and the cover surface. Additionally, at least a portion of the chamber housing can be substantially transparent. The workpiece can also be partially or completely transparent. Moreover, the workpiece surface can be substantially planar.

In some embodiments, the chamber housing includes a planar section that is substantially parallel to the workpiece surface. In one such embodiment, the seal assembly is positioned substantially between the planar section and the workpiece surface. Additionally, the chamber housing can further include a flange section that cantilevers away from the planar section toward the workpiece surface. In one such embodiment, the seal assembly is positioned substantially between the flange section and the workpiece surface.

In one embodiment, the first seal contact region and the second seal contact region cooperate to exert a first force on at least one of the workpiece surface and the cover surface. Further, in such embodiment, the seal pressure is controlled to generate a second force on the at least one of the workpiece surface and the cover surface. Additionally, in one such embodiment, the first force is approximately equal in magnitude and opposite in direction to the second force. Stated in another fashion, the seal pressure is controlled so that the net force on the workpiece surface is approximately equal to zero. This reduces the likelihood of the seal assembly distorting the workpiece.

Further, the present invention is also directed to a stage assembly, an exposure apparatus, a method for providing a sealed chamber adjacent to a workpiece, a method for manufacturing an exposure apparatus, and a method for manufacturing a device.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic illustration of an exposure apparatus having features of the present invention;

FIG. 2A is a perspective view of a portion of a stage assembly, a workpiece, and a first embodiment of a chamber assembly having features of the present invention;

FIG. 2B is a simplified top view of the stage and the chamber assembly illustrated in FIG. 2A;

FIG. 2C is a cutaway view of taken along line 2C-2C of FIG. 2B;

FIG. 2D is an enlarged view taken on line 2D-2D in FIG. 2C;

FIG. 3A is a simplified cross-sectional view of the workpiece, another embodiment of the stage, and another embodiment of a chamber assembly having features of the present invention;

FIG. 3B is an enlarged view taken on line 3B-3B in FIG. 3A;

FIG. 4 is a simplified cross-sectional view of a portion of the workpiece, and a portion of another embodiment of a seal assembly having features of the present invention;

FIG. 5 is a simplified cross-sectional view of a portion of the workpiece, and a portion of yet another embodiment of a seal assembly having features of the present invention;

FIG. 6 is a simplified cross-sectional view of a portion of the workpiece, and a portion of still another embodiment of a seal assembly having features of the present invention;

FIG. 7A is a flow chart that outlines a process for manufacturing a device in accordance with the present invention; and

FIG. 7B is a flow chart that outlines device processing in more detail.

### DESCRIPTION

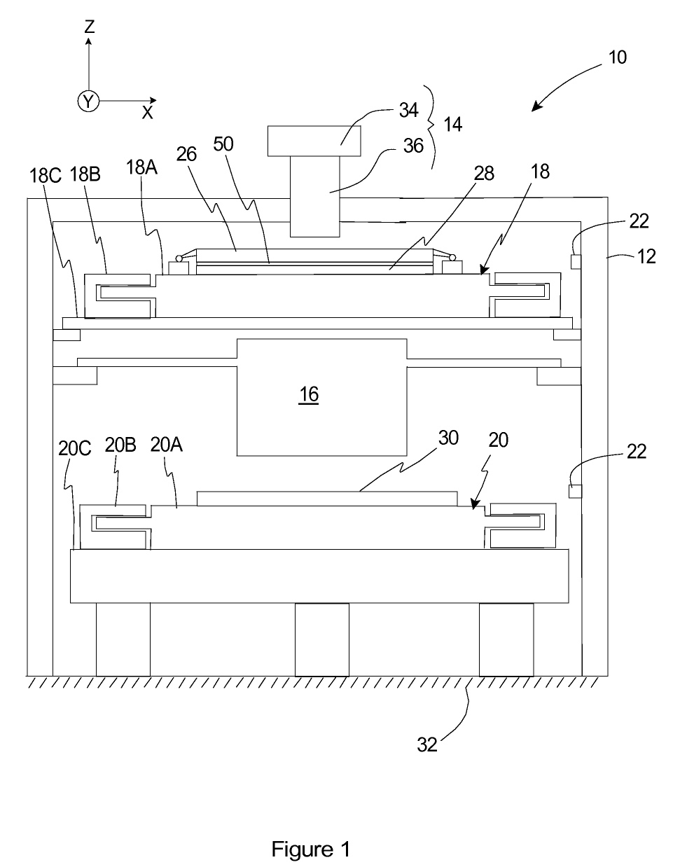

FIG. 1 is a schematic illustration of a precision assembly, namely an exposure apparatus 10 having features of the present invention. The exposure apparatus 10 includes an apparatus frame 12, an illumination system 14 (irradiation apparatus), an optical assembly 16, a first stage assembly 18, a second stage assembly 20, a measurement system 22, a control system 24, and a chamber assembly 26. The design of the components of the exposure apparatus 10 can be varied to suit the design requirements of the exposure apparatus 10.

In one embodiment, the exposure apparatus 10 is particularly useful as a lithographic device that transfers a pattern (not shown) of a liquid crystal display (LCD) device from a mask 28, e.g., an LCD mask, (also sometimes referred to herein as a reticle or a workpiece) onto a substrate 30. In this embodiment, the mask 28 is at least partly transparent.

However, the use of the exposure apparatus 10 provided herein is not limited to an LCD photolithography system that exposes a liquid crystal display device pattern from the mask 28 onto a rectangular glass plate, i.e. the substrate 30. The exposure apparatus 10, for example, can be used as a photolithography system for semiconductor manufacturing or a photolithography system for manufacturing a thin film magnetic head. Further, the present invention can also be applied to a proximity photolithography system that exposes a mask pattern from a mask to a substrate with the mask located close to the substrate without the use of a lens assembly.

In FIG. 1, the exposure apparatus 10 mounts to a mounting base 32, e.g., the ground, a base, or floor or some other supporting structure.

As an overview, in certain embodiments, the chamber assembly 26 is uniquely designed to counteract the influence of gravity on the workpiece (e.g. the mask 28, such as an LCD mask) and inhibit sagging of the workpiece 28. Further, the chamber assembly 26 utilizes a unique seal assembly 50 (partly shown in FIG. 1) that minimizes and/or reduces the influence of preload forces on the surface being sealed to, e.g., the surface of the mask 28. With the present design, the seal assembly 50 is able to seal against a low pressure differential without a separate preload force on the seal assembly 50 and the workpiece 28. Further, the present invention can achieve these benefits regardless of the size of the mask 28.

A number of Figures include an orientation system that illustrates the X axis, the Y axis that is orthogonal to the X axis, and the Z axis that is orthogonal to the X and Y axes. It should be noted that any of these axes can also be referred to as the first, second, and/or third axes.

There are a number of different types of lithographic devices. For example, the exposure apparatus 10 can be used as a scanning type photolithography system that exposes the pattern from the mask 28 onto the substrate 30 with the mask 28 and the substrate 30 moving synchronously. Alternatively, the exposure apparatus 10 can be a step-and-repeat type photolithography system that exposes the mask 28 while the mask 28 and the substrate 30 are stationary.

The apparatus frame 12 is rigid and supports the components of the exposure apparatus 10. The apparatus frame 12 illustrated in FIG. 1 supports the first stage assembly 18, the optical assembly 16 and the illumination system 14 above the mounting base 30. In alternative embodiments, the connections or contacts between the apparatus frame 12 and the components of the exposure apparatus 10 can be substantially rigid or they can be at least somewhat flexible so as to provide some degree of vibration isolation.

The illumination system 14 includes an illumination source 34 and an illumination optical assembly 36. The illumination source 34 emits a beam (irradiation) of light energy. The illumination optical assembly 36 guides the beam of light energy from the illumination source 34 to the optical assembly 16. The beam selectively illuminates different portions of the mask 28 and exposes the substrate 30. In FIG. 1, the illumination source 34 is illustrated as being supported above the first stage assembly 18. Typically, however, the illumination source 34 is secured to one of the sides of the apparatus frame 12 and the energy beam from the illumination source 34 is directed to above the first stage assembly 18 with the illumination optical assembly 36. In alternative embodiments, the illumination system 14 may include more than one illumination source 34 and more than one illumination optical assembly 36 to compensate for the relatively large size of the mask 28.

The illumination source 34 can be a g-line source (436 nm), an i-line source (365 nm), a KrF excimer laser (248 nm), an ArF excimer laser (193 nm), a F₂ laser (157 nm), or an EUV source (13.5 nm). Alternatively, for example, the illumination source 34 can generate charged particle beams such as an x-ray or an electron beam. Still alternatively, the illumination source 34 can include wavelengths different from those specifically noted above.

The optical assembly 16 projects and/or focuses the light passing through the mask 28 to the substrate 30. Depending upon the design of the exposure apparatus 10, the optical assembly 16 can magnify or reduce the image illuminated on the mask 28. The optical assembly 16 need not be limited to a reduction system. It could also be a 1x or magnification system.

The first stage assembly 18 holds and positions the workpiece 28 relative to the optical assembly 16 and the substrate 30. Further, in certain embodiments, the first stage assembly 18 concurrently moves at least a portion of the chamber assembly 26 with the workpiece 28. The first stage assembly 18 can include a first stage 18A that includes a chuck that retains the workpiece 28 and a portion of the chamber assembly 26, a first stage mover 18B that moves the first stage 18A with one or more degrees of movement, and a first stage base 18C that supports the first stage 18A.

Somewhat similarly, the second stage assembly 20 holds and positions the substrate 30 with respect to the projected image of the illuminated portions of the mask 28. The second stage assembly 20 can include a second stage 20A that retains the substrate 30, a second stage mover 20B that moves the second stage 20A with one or more degrees of movement, and a second stage base 20C that supports the second stage 20A.

The measurement system 22 monitors movement of the mask 28 and the substrate 30 relative to the optical assembly 16 or some other reference. With this information, the control system 24 can control the first stage assembly 18 to precisely position the mask 28 and the second stage assembly 20 to precisely position the substrate 30. For example, the measurement system 22 can utilize multiple laser interferometers, encoders, and/or other measuring devices.

The control system 24 is connected to the first stage assembly 18, the second stage assembly 20, and the measurement system 22. The control system 24 receives information from the measurement system 22 and controls the stage assemblies 18, 20 to precisely position the mask 28 and the substrate 30. The control system 24 can include one or more processors and circuits.

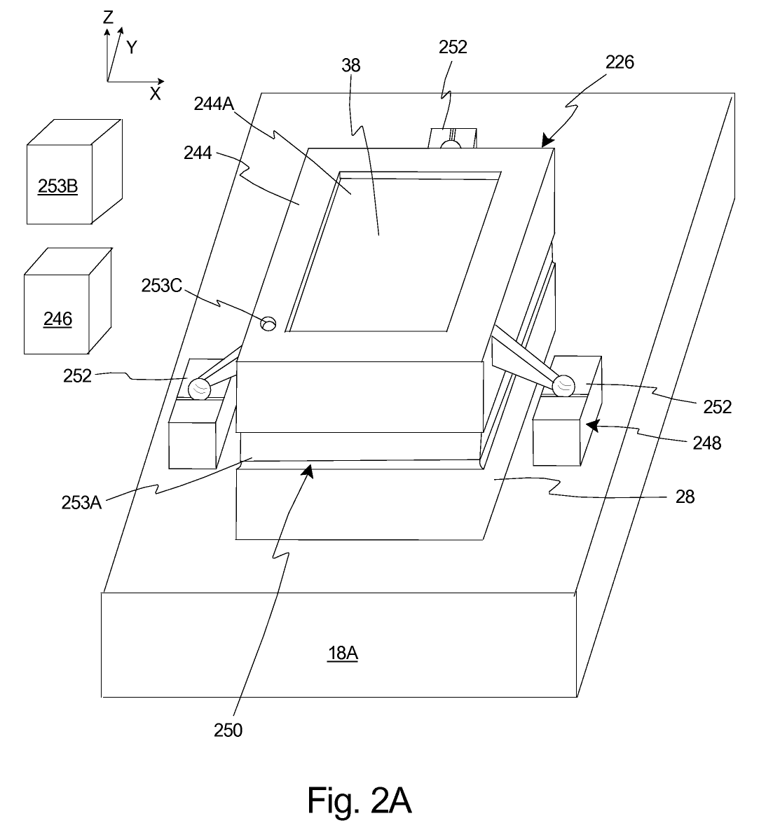

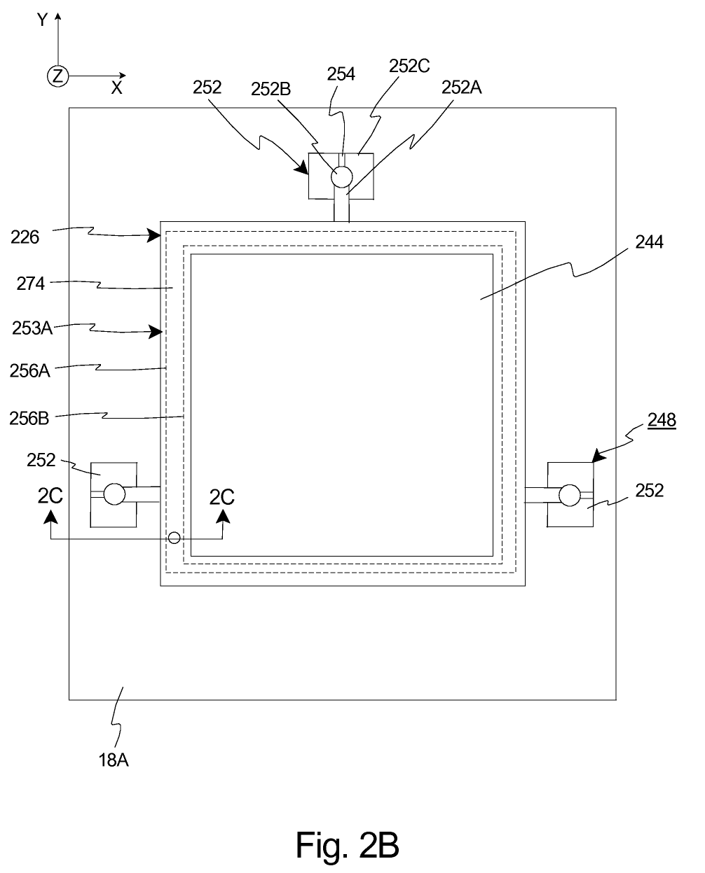

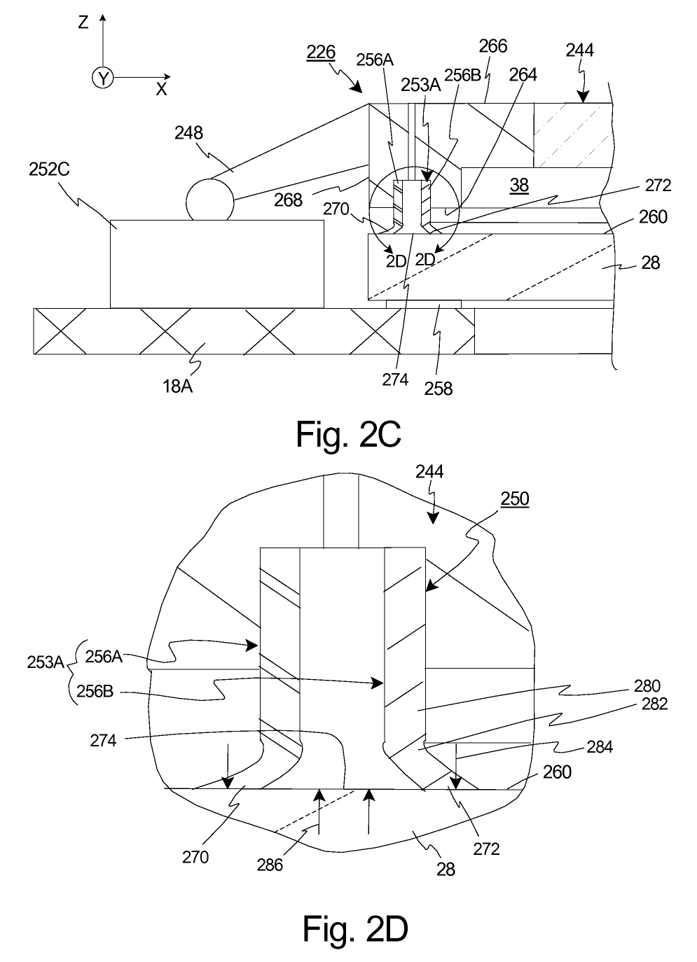

The chamber assembly 26 provides a sealed chamber 38 (illustrated in FIG. 2A) adjacent to the mask 28. Additionally, the chamber assembly 26 controls the environment within the sealed chamber 38. The desired environment created and/or controlled within the sealed chamber 38 by the chamber assembly 26 can be selected according to the design of the rest of the components of the exposure apparatus 10. For example, the desired controlled environment within the sealed chamber 38 can be a low vacuum type environment. In this embodiment, the chamber assembly 26 removes the fluid from the sealed chamber 38.

A photolithography system (an exposure apparatus) according to the embodiments described herein can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

FIG. 2A is a perspective view of the first stage 18A, the workpiece 28, and a first embodiment of a chamber assembly 226 having features of the present invention. In this embodiment, the first stage 18A supports both the workpiece 28 and the chamber assembly 226. Further, in this embodiment, the first stage 18A and the workpiece 28 are each generally rectangular in shape. Moreover, in this embodiment the first stage 18A includes a rectangular shaped aperture that allows energy that passes through the workpiece to pass through the first stage 18A. Alternatively, the first stage 18A and the workpiece 28 can have another shape.

In certain embodiments, the first stage 18A, the workpiece 28, and the chamber assembly 226 are substantially surrounded by an environment 240 having an environmental pressure. For example, in some embodiments, the environmental pressure is approximately equal to the atmospheric pressure.

The design of the chamber assembly 226 can be varied depending on the specific requirements of the exposure apparatus 10 (illustrated in FIG. 1) and the workpiece 28. In FIG. 2A, the chamber assembly 226 includes a chamber housing 244, a chamber pressure source 246, one or more conduits (not shown), a cover support assembly 248, and a seal assembly 250. Alternatively, the chamber assembly 226 can be designed without the cover support assembly 248.

The chamber housing 244 cooperates with the mask 28 and the seal assembly 250 to define the sealed chamber 38 adjacent to the mask 28. In FIG. 2A, the chamber housing 244 is shaped somewhat similar to an open box that is inverted. Moreover, the chamber housing 244 can include a transparent region 244A that allows for the transmission of energy (e.g light) through the chamber housing 244 to the workpiece 28. Alternatively, the entire chamber housing 244 can be made to be transparent to the energy that is directed at the workpiece 28.

The chamber pressure source 246 is in fluid communication with and controls a chamber pressure within the sealed chamber 38. Stated another way, the chamber pressure source 246 can utilize the one or more conduits, e.g., hoses, to provide fluid to and/or remove fluid from the sealed chamber 38 in order to control the chamber pressure within the sealed chamber 38. In certain embodiments, the chamber pressure source 246 controls the chamber pressure to be different than the environmental pressure so as to reduce and minimize any sagging of the mask 28 due to the forces of gravity. More particularly, in certain embodiments where the mask 28 is positioned substantially beneath the chamber housing 244, the chamber pressure source 246 controls the chamber pressure to be less than the environmental pressure. In one non-exclusive embodiment, the chamber pressure source 246 can control the chamber pressure so that the chamber pressure is at a slight vacuum (e.g. less than the environmental pressure by between approximately 200 and 600 Pascals). In one such embodiment, the chamber pressure source 246 controls the chamber pressure so that the chamber pressure is less than the environmental pressure by between approximately 350 and 400 Pascals. With this design, because the environmental pressure below the mask 28 is greater than the chamber pressure above the mask 28, the influence of gravity on the mask 28 can be compensated for.

Alternatively, in certain embodiments where the mask 28 is positioned substantially above the chamber housing 244, the chamber pressure source 246 can control the chamber pressure to be greater than the environmental pressure so as to minimize any sagging of the mask 28 due to the forces of gravity.

The cover support assembly 248 provides support for the chamber housing 244 relative to the mask 28 and/or relative to the stage 18A. With this design, the cover support assembly 248 reduces or inhibits the chamber housing 244 applying weight to the mask 28 and from deforming the mask 28. The design of the cover support assembly 248 can be varied to suit the specific requirements of the chamber assembly 226 and/or the specific requirements of the exposure apparatus 10. Alternatively, as noted above, the chamber assembly 226 can be designed without the cover support assembly 248.

In certain embodiments, the cover support assembly 248 includes a plurality of spaced apart cover supports 252 that cooperate to support the chamber housing 244 relative to the mask 28, and/or to inhibit movement of the chamber housing 244 relative to the mask 28. In the embodiment illustrated in FIG. 2A, the cover support assembly 248 includes three cover supports 252 that are substantially equally spaced apart from each other around the perimeter of the chamber housing 244. In this embodiment, the cover support assembly 248 supports the chamber housing 244 in a substantially kinematic fashion above the stage 18A. In alternative embodiments, the cover support assembly 248 can be designed with more than three or less than three cover supports 252. Still alternatively, the cover supports 252 can be positioned in different locations around the perimeter of the chamber housing 244.

The seal assembly 250 seals the chamber housing 244 to the mask 28 while reducing the likelihood of deforming the workpiece 28. The design of the seal assembly 250 can be varied to suit the specific requirements of the chamber assembly 226, the workpiece 28, and/or the specific requirements of the exposure apparatus 10. In one embodiment, the seal assembly 250 includes (i) a seal body 253A that is positioned substantially between the chamber housing 244 and the mask 28, and (ii) a seal pressure source 253B that is in fluid communication with and that controls a seal pressure in the seal body 253A. In certain embodiments, the seal assembly 250 can further include one or more conduits (not shown) through which the seal pressure source 253B can be in fluid communication with the seal body 253A.

In FIG. 2A, the seal body 253A is generally rectangular frame shaped to seal the gap between the chamber housing 244 and the workpiece 28.

Alternatively, the seal body 253A can have another shape than rectangular frame shaped.

Additionally, the seal body 253A can include a seal inlet 253C into the seal body 253A that extends through a portion of the chamber housing 244. In this embodiment, the seal pressure source 253B is in fluid communication with the seal inlet 253C. Stated another way, the seal pressure source 253B can utilize the one or more conduits, e.g., hoses, to provide fluid to and/or remove fluid from the seal body 253A via the seal inlet 253C in order to control the seal pressure within the seal body 253A.

FIG. 2B is a simplified top view of the stage 18A and the chamber assembly 226 illustrated in FIG. 2A. In particular, FIG. 2B illustrates the design and positioning of the cover support assembly 248 in greater detail.

As noted above, in this embodiment, the cover support assembly 248 includes three cover supports 252 that are spaced apart from each other around the perimeter of the chamber housing 244. In one embodiment, each of the cover supports 252 is substantially similar in design. Alternatively, each of the cover supports 252 can be different in design.

In FIG. 2B, each cover support 252 includes a connector arm 252A, a support ball 252B, and a support pad 252C. The connector arm 252A includes (i) a proximal end that is secured to the chamber housing 244, and (ii) a distal end that extends outwardly away from the chamber housing 244 and that is coupled to the support ball 252B. The support ball 252B is a spherical ball that interacts with the support pad 252C to inhibit movement along two degrees of movement. In one embodiment, the support pad 252C is fixedly secured to the stage 18A, is positioned substantially beneath the support ball 252B around the perimeter of the chamber housing 244, and directly supports the support ball 252B. In this embodiment, the support pad 252C is substantially rectangular block shaped and includes a groove 254 along a top surface of the support pad 252C. The groove 254 can be substantially V-shaped and is designed to constrain the movement of the support ball 252B relative to the support pad 252C along two degrees of movement.

During use, for each cover support 252, the support ball 252B is positioned within the respective groove 254 so that the support ball 252B can only move along the groove 254 and the support ball 252B can not move in and out of the groove 254. With this design, the three cover supports 252 cooperate to constrain the relative movement of the chamber housing 244 in six degrees of movement. Stated another way, the three cover supports 252 cooperate to inhibit substantially all movement of the chamber housing 244 relative to the stage 18A. As a result, the chamber housing 244, and the mask 28 move concurrently with the stage 18A.

Additionally, FIG. 2B illustrates the seal body 253A (illustrated in phantom). In this embodiment, the seal body 253A includes a first seal 256A (illustrated in phantom), and a second seal 256B (illustrated in phantom) that is spaced apart from the first seal 256A. In this embodiment, the chamber housing 244 is generally rectangular shaped, and each seal 256A, 256B is generally rectangular tube shaped to seal the gap between the chamber housing 244 and the workpiece 28 (not shown in FIG. 2B). Further, in this embodiment, (i) the seals 256A, 256B cooperate to define a seal gap 274 therebetween, and (ii) the first seal 256 encircles the second seal 256B.

FIG. 2C is a cutaway view of the stage 18A, the workpiece 28, and the chamber assembly 226 taken along line 2C-2C in FIG. 2B. In this embodiment, the workpiece 28 is supported by and moves with the stage 18A. For example, the stage 18A can include a vacuum chuck 258 or another type of holder that retains and selectively secures the workpiece 28 to the stage 18A.

In FIG. 2C, the workpiece 28 includes a workpiece surface 260 that faces in a generally upward direction toward the chamber assembly 226. In one embodiment, the workpiece surface 260 is substantially planar. Alternatively, the workpiece surface 260 can be designed to include one or more surface features that provide some texture, roughness or contours to the workpiece surface 260. Still alternatively, the workpiece 28 can be positioned in a different orientation relative to the chamber assembly 226. In such embodiments, the workpiece surface 260 will still be oriented so as to generally face toward the chamber assembly 226.

As shown in this embodiment, the chamber assembly 226 can include the chamber housing 244, the cover support assembly 248, and a first embodiment of the seal body 253A having features of the present invention. The design of these components can be varied to suit the specific requirements of the chamber assembly 226 and/or the exposure apparatus 10 (illustrated in FIG. 1).

In one embodiment, the chamber housing 244 is supported relative to the stage 18A with the cover support assembly 248. As noted above, the chamber housing 244 cooperates with the mask 28 and the seal body 253A to define the sealed chamber 38. In this embodiment, the chamber housing 244 includes a cover surface 264 that faces in a generally downward direction toward the workpiece surface 260 of the mask 28. In some embodiments, as provided above, at least a portion of the chamber housing 244 is substantially transparent so as to allow the beam of light energy from the illumination source 34 (illustrated in FIG. 1) to pass through the chamber housing 244 to the mask 28.

In the embodiment illustrated in FIG. 2C, the chamber housing 244 includes a generally planar section 266 that is substantially parallel to the workpiece surface 260, and a flange section 268 that is positioned near the outer perimeter of the planar section 266 and that cantilevers downward away from the planar section 266 toward the workpiece surface 260. In this embodiment, substantially all of the planar section 266 can be transparent.

As discussed in detail above, the cover support assembly 248 provides additional support for the chamber housing 244 relative to the mask 28 and/or relative to the stage 18A. In FIG. 2C, the support pad 252C of the one cover support 252 illustrated therein is fixedly secured to and supported by the stage 18A. Alternatively, the support pads 252C can be secured to a cover stage (not shown) that is spaced apart from the stage 18A, and this cover stage can independently support the chamber housing 244 relative to the mask 28 and/or relative to the stage 18A. In such embodiments, the cover stage can be moved concurrently with the stage 18A so that chamber housing 244 is moved concurrently with the mask 28 and the stage 18A. Still alternatively, the cover stage can be moved independently of the mask 28 and the stage 18A so as to allow the mask 28 to be easily interchanged with another workpiece.

In FIG. 2C, the seal body 253A extends between the chamber housing 244 and the workpiece surface 260 and seals the chamber housing 244 to the workpiece 28. Stated in another fashion, the seal body 253A is positioned at least partly between the workpiece surface 260 and the cover surface 264 to seal the workpiece surface 260 to the cover surface 264. In one embodiment, portions or all of the seal body 253A can be made from a resilient material so as to improve the effectiveness and reliability of the seal between the workpiece surface 260 and the cover surface 264. As provided herein, the seal body 253A can be designed to be as compliant as possible so that the seal body 253A will not transfer any loads between the surfaces 260, 264 that are being sealed.

In one embodiment, the seal body 253A includes (i) the first seal 256A having a first seal contact region 270 that engages the workpiece surface 260, and (ii) the second seal 256B having a second seal contact region 272 that also engages the workpiece surface 260. Further, the seal body 253A defines the seal gap 274 adjacent to at least one of the chamber housing 244 and the workpiece 28. Further, the seal pressure source 253B (illustrated in FIG. 2A) controls a seal pressure within the seal gap 274.

In some embodiments, the first seal contact region 270 is spaced apart from the second seal contact region 272 to define the seal gap 274. For example, in the embodiment illustrated in FIG. 2C, the first seal contact region 270 substantially encircles and is spaced apart from the second seal contact region 272. In such embodiments, the seal gap 274 is positioned substantially between the first seal contact region 270 and the second seal contact region 272. Alternatively, the seal body 253A can be designed so that the first seal contact region 270 and the second seal contact region 272 are integrally formed in a unitary structure. In such alternative embodiments, one or more apertures or grooves (not illustrated) can be positioned within the seal body 253A so as to define the seal gap 274.

As noted above, the seal pressure source 253B controls the seal pressure within the seal gap 274. In certain embodiments, the seal pressure source 253B controls the seal pressure within the seal gap 274 so that the seal pressure is different than the chamber pressure and the environmental pressure. More particularly, in some such embodiments, the seal pressure source 253B controls the seal pressure within the seal gap 274 so that the seal pressure is less than the chamber pressure and the environmental pressure. For example, the seal pressure can be maintained at a relatively high vacuum. As non-exclusive examples, the seal pressure can be approximately negative one (−1) kPa, negative ten (−10) kPa , negative thirty (−30) kPa, negative fifty (−50) kPa, negative sixty (−60) kPa, negative seventy (−70) kPa, or negative eighty (−80) kPa.

With the present design, the seal body 253A is able to seal against a low pressure differential (e.g. 400 Pa) between the environmental pressure and the chamber pressure without a separate preload force on the seal body 253A. In contrast, if a conventional seal was utilized, the seal must be soft and a relatively large preload force must be applied to the seal so that the seal material covers and partially penetrates the grooves and voids in the workpiece surface 260. This preload force of a prior art seal can deform the workpiece 28. Further, it may be difficult to find a seal material that is soft and smooth enough to achieve this purpose and meet other material compatibility requirements.

FIG. 2D is an enlarged view taken on line 2D-2D in FIG. 2C. As illustrated, the seal body 253A includes the first seal 256A having the first seal contact region 270 and the second seal 256B having the second seal contact region 272, and the seal body 253A defines the seal gap 274 adjacent to a surface. For example, the first seal contact region 270 and the second seal contact region 272 can cooperate to define at least a portion of the seal gap 274 adjacent to at least one of the workpiece surface 260 as illustrated in FIG. 2D, or the cover surface 264.

In one embodiment, each seal 256A, 256B is made from a resilient material such as rubber, and includes a vertical portion 280 and a flared portion 282 that is positioned adjacent to the vertical portion 280 and extends downward from the vertical portion 280. In FIG. 2D, the flared portion 282 of the first seal 256A that contacts the workpiece surface 260 defines the first seal contact region 270, and the flared portion 282 of the second seal 256B that contacts the workpiece surface 260 defines the second seal contact region 272. As illustrated, the flared portion 282 of the first seal 256A extends somewhat away from the flared portion 282 of the second seal 256B, such that the size of the seal gap 274 is greater immediately adjacent to the workpiece surface 260 as compared to the size of the seal gap 274 between the vertical portion 280 of the first seal 256A and the vertical portion 280 of the second seal 256B.

In order to create an effective seal with the workpiece surface 260, the seal body 253A must be forced against the workpiece surface 260. In this embodiment, the seal pressure in the seal gap 274 causes the first seal contact region 270 and the second seal contact region 272 to be pulled against the workpiece surface 260 and causes the seal contact regions 270, 272 to exert a first force 284 (illustrated as arrows pointing in a generally downward direction) onto the workpiece surface 260. In different non-exclusive embodiments, the first force 284 can include a single discrete force, a plurality of discrete spaced apart forces, a single continuous force, a set of continuous forces, or some combination thereof.

More specifically, in FIG. 2D where the workpiece 28 is positioned beneath the chamber housing 244, the seal pressure causes the first contact region 270 and the second contact region 272 cooperate to exert the first force 284 in a generally downward direction onto the workpiece surface 260. The magnitude of the first force 284 depends, at least in part, upon the magnitude of the seal pressure. Thus, the seal pressure can be controlled to control the magnitude of the first force 284. For example, in certain embodiments, the supporting structure can be made compliant and aligned to only support the weight of the chamber housing 244. In such embodiments, the seal pressure partially controls the magnitude of the first force 284.

It should be noted that in certain alternative embodiments, if the supports for the chamber housing 244 are rigid and the chamber cover is sufficiently heavy, the first force 284 is not defined by the seal pressure but rather by the distance by which it is compressed. This distance is defined by the geometry and alignment of the supporting structure. In such embodiments, the seal pressure is then adjusted to counteract the first force 284.

Additionally, in this embodiment, because the seal pressure in the seal gap 274 is less than the environmental pressure on the opposite side of the workpiece 28, an upward second force 286 (illustrated as arrows) is generated onto the workpiece surface 260. In different non-exclusive embodiments, the second force 286 can include a single discrete force, a plurality of discrete spaced apart forces, a single continuous force, a set of continuous forces, or some combination thereof.

It should be noted that the magnitude of second force 284 will depend upon (i) the magnitude of the difference between the seal pressure and the environmental pressure, and (ii) the surface area of the seal gap 274 on the workpiece surface 260. Thus, the seal body 253A can be designed to achieve the desired surface area of the seal gap 274, and the seal pressure can be controlled to control the magnitude of the second force 286.

In one embodiment, the seal body 253A can be designed and the seal pressure can be controlled so that the second force 286 is approximately equal in magnitude and opposite in direction to the first force 284. Stated in another fashion, the distance between the first seal 256A and the second seal 256B at the workpiece surface 260 can be adjusted so that second force 286 perfectly counteracts the first force 284. With this design, the seal body 253A is designed so that the net force by the seal assembly 250 acting on the workpiece 26 is approximately equal to zero, and the seal body 253A does not deform or only minimally deforms the workpiece 28. This way there is a very small and contained force loop and the net force on the workpiece 28 outside of that loop is zero even if there is a large preload first force 284 at the first seal contact region 270 and the second seal contact region 272. For example, in certain alternative, non-exclusive embodiments, the magnitude of the second force 286 can be within approximately zero (0%), one (1%), two (2%), five (5%) or ten percent (10%) of the magnitude of the first force 284. However, in other alternative embodiments, the magnitude of the second force 286 can be within approximately twenty (20%), thirty (30%), fifty (50%), seventy (70%), or one hundred percent (100%) of the magnitude of the first force 284.

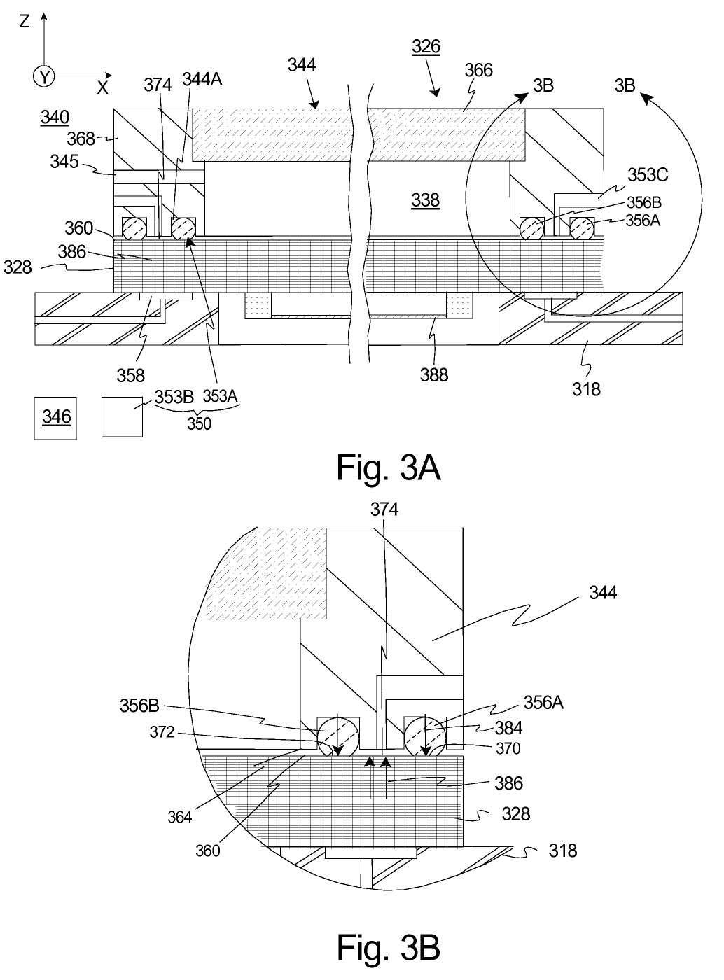

FIG. 3A is a simplified side cross-sectional view of a portion of a stage 318, a workpiece 328, and another embodiment of a chamber assembly 326 having features of the present invention. The stage 318 and the workpiece 328 are somewhat similar to the corresponding components described above and illustrated in FIGS. 2A-2D. More specifically, the stage 318 again supports the workpiece 328 and the stage again includes a vacuum chuck 358 that retains the workpiece 328. However, in FIG. 3A, a pellicle 388 is secured to the underside of the workpiece 328 and is positioned substantially beneath the workpiece 328. The pellicle 388 includes a very thin, clear surface that is spaced apart from the underside of the workpiece 328. The pellicle 388 is designed to protect or shield the workpiece 328 from unwanted particles that may impact the integrity of the workpiece 328, such that the unwanted particles will end up on the bottom surface of the pellicle 388 instead of on the underside of the workpiece 328. Further, the thin, clear surface of the pellicle 388 is positioned spaced apart from the underside of the workpiece 328 a sufficient distance so that any unwanted particles that do adhere to the bottom surface of the pellicle 388 will be too out of focus to print when the illumination optical assembly 36 (illustrated in FIG. 1) guides the beam of light energy from the illumination source 34 (illustrated in FIG. 1) through the workpiece 328 and to the optical assembly 16 (illustrated in FIG. 1).

In FIG. 3A, the chamber assembly 326 includes (i) a chamber housing 344, (ii) a chamber pressure source 346 that is in fluid communication with a housing inlet 345 to the chamber housing 344, and (iii) a seal assembly 350 that are somewhat similar to the corresponding components described above and illustrated in FIGS. 2A-2D. Similar to the previous embodiment, the chamber housing 344 cooperates with the mask 328 and the seal assembly 350 to define a sealed chamber 338 adjacent to the mask 328. Additionally, the chamber pressure source 346 controls a chamber pressure within the sealed chamber 338. For example, the chamber pressure source 346 can control the chamber pressure to be different that an environmental pressure in the environment 340 that surrounds the chamber assembly 326 so as to minimize any sagging of the mask 328 due to the forces of gravity.

As shown in FIG. 3A, the chamber housing 344 includes a planar section 366 that is substantially parallel to the workpiece surface 360, and a flange section 368 that extends downward from the planar section 366. Further, at least a portion of the planar section 366 can be made from a substantially transparent material.

Additionally, in FIG. 3A, the seal assembly 350 includes (i) a seal body 353A that seals the chamber housing 344 to the mask 328, and (ii) a seal pressure source 353B that is in fluid communication with and that controls a seal pressure of a seal gap 374 in the seal body 353A. In FIG. 3A, the seal body 353A again includes a first seal 356A and a second seal 356B that cooperate to define the seal gap 374. In this embodiment, each seal 356A, 356B is a rectangular “O” ring type seal that has a circular shaped cross-section. Further, the first seal 356A encircles the second seal 356B. In this embodiment, each seal 356A, 356B is positioned in its own slot 344A in the chamber housing 344 adjacent to the workpiece 328. In alternative embodiments, the rectangular “O” ring type seal can have corners that are somewhat rounded.

In this embodiment, the seal assembly 350 also includes a seal inlet 353C that extends into the seal gap 374 that extends through a portion of the chamber housing 344. In this embodiment, the seal pressure source 353B is in fluid communication with the seal inlet 353C.

FIG. 3B is an enlarged view taken on line 3B-3B in FIG. 3A. As noted above, the seals 356A, 356B cooperate to seal the chamber housing 344 to the workpiece 328. In this embodiment, the first seal 356A again includes a first seal contact region 370 that engages the workpiece surface 360, and the second seal 356B includes a second seal contact region 372 that engages the workpiece surface 360. In this embodiment, the seals 356A, 356B cooperate to define the seal gap 374 between the seal contact regions 370, 372 of the seals 356A, 356B and adjacent to at least one of the cover surface 364 and the workpiece surface 360. More particularly, the seal gap 374 is positioned substantially between the first seal contact region 370 and the second seal contact region 372. The seal pressure source 376 is adapted to control the seal pressure within the seal gap 374.

As noted above, the seal pressure source 353B (illustrated in FIG. 3A) controls the seal pressure within the seal gap 374. In this embodiment, the seal pressure in the seal gap 374 again causes the seal contact regions 370, 372 to be pulled against the workpiece surface 360 and causes the seal contact regions 370, 372 to exert a first force 384 (illustrated as arrows) downward onto the workpiece surface 360. The magnitude of the first force 384 again depends, in part, upon the magnitude of the seal pressure. Further, in certain alternative embodiments, the geometry and alignment of the supporting structure can again impact the magnitude of the first force 384 and the seal pressure. In such embodiments, the seal pressure is then adjusted to counteract the first force 384.

Additionally, in this embodiment, because the seal pressure in the seal gap 374 is less than the environmental pressure on the opposite side of the workpiece 328, a second force 386 (illustrated as arrows) is generated onto the workpiece surface 360. The magnitude of the second force 386 will depend upon (i) the magnitude of the difference between the seal pressure and the environmental pressure, and (ii) the surface area of the seal gap 374 on the workpiece surface 360.

In this embodiment, the seals 356A, 356B can be positioned and the seal pressure can be controlled so that the second force 386 is approximately equal in magnitude and opposite in direction to the first force 384. Stated in another fashion, the distance between the seals 356A, 356B at the workpiece surface 360 can be adjusted so that second force 386 almost perfectly counteracts the first force 384. With this design, the net forces applied onto the workpiece surface 360 from the seals 356A, 356B and related assembly can be approximately zero.

Referring back to FIG. 3A, in addition, in certain embodiments, the seal assembly 350 can be used as a vacuum chuck that mechanically couples two objects that are being sealed to each other. For example, if a slightly stiffer seal or O-ring material is used or a larger distance is created between the seals 356A, 356B, then the seals 356A, 356B and the seal pressure source 353B can be used as a chuck to mechanically hold down the upper object onto the lower object. Moreover, in such embodiments, the parameters can still be adjusted such that under normal operation the net force exerted onto the lower object by the upper object is still approximately zero.

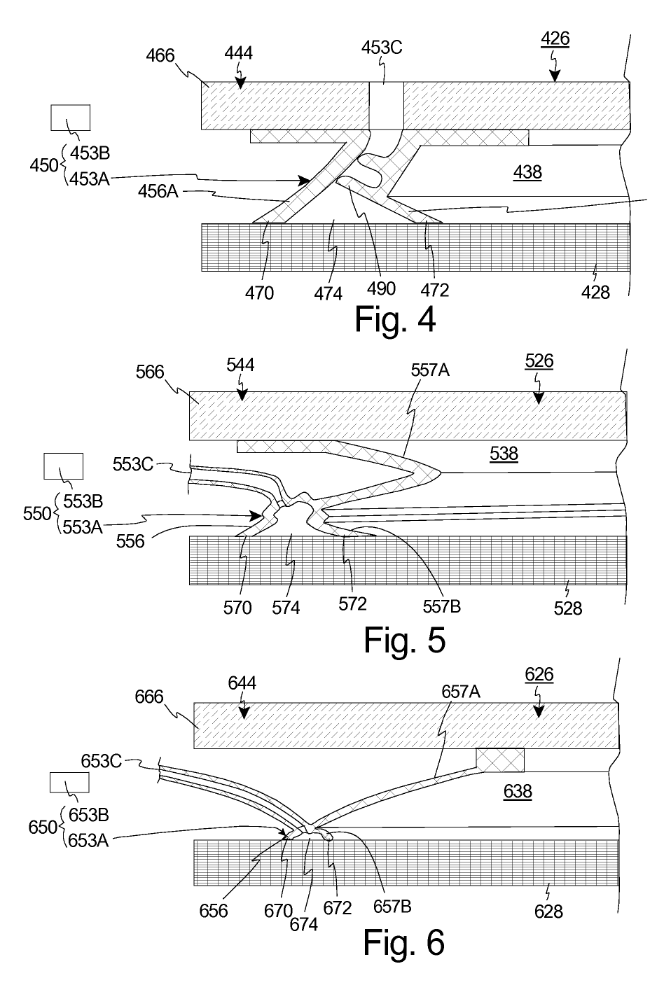

FIG. 4 is a simplified cross-sectional view of a portion of a workpiece 428 and a portion of another embodiment of a chamber assembly 426 having features of the present invention. In this embodiment, the chamber assembly 426 includes (i) a chamber housing 444, (ii) a chamber pressure source 446, and (iii) a seal assembly 450 that are somewhat similar to the corresponding components described above. Similar to the previous embodiments, the chamber housing 444 cooperates with the workpiece 428 and the seal assembly 450 to define a sealed chamber 438 adjacent to the workpiece 428. Additionally, the chamber pressure source 446 controls a chamber pressure within the sealed chamber 438 so as to minimize any sagging of the workpiece 428 due to the forces of gravity.

In FIG. 4, the chamber housing 444 includes a planar section 466 that is substantially parallel to the workpiece 428, and does not include a flange section like the previous embodiments. Additionally, in FIG. 4, the seal assembly 450 includes (i) a seal body 453A that seals the chamber housing 444 to the workpiece 428, and (ii) a seal pressure source 453B that is in fluid communication with and that controls a seal pressure of a seal gap 474 in the seal body 453A. In FIG. 4, the seal body 453A again includes a first seal 456A and a second seal 456B that cooperate to define the seal gap 474.

In this embodiment, the seal assembly 450 also includes a seal inlet 453C that extends through a portion of the chamber housing 444 and into the seal gap 474, and the seal pressure source 453B is in fluid communication with the seal inlet 453C.

Moreover, in this embodiment, the first seal 456A again includes a first seal contact region 470 that engages the workpiece 428, and the second seal 456B includes a second seal contact region 472 that engages the workpiece 428. Again, in this embodiment, the seal pressure source 453B controls the seal pressure within the seal gap 474 to pull the seal contact regions 470, 472 against the workpiece 428 and to seal the chamber housing 444 to the workpiece 428.

In this embodiment, each seal 456A, 456B can be a flexible member that is made from rubber or another substantially compliant material. Additionally, each seal 456A, 456B can be attached to the chamber housing 444 and extend in a generally downward direction from the chamber housing 444 to the workpiece 428. In certain non-exclusive alternative embodiments, the seals 456A, 456B can be attached to the chamber housing 444 by clamps, adhesives or by some other means.

In some embodiments, the seals 456A, 456B are made as separately extruded parts that are individually attached to the chamber housing 444.

Alternatively, the seals 456A, 456B can be made as a unitary structure with intermittent cuts or apertures made to create a path of fluid communication between the seal inlet 453C and the seal gap 474. Additionally, as shown in FIG. 4, one or more of the seals 456A, 456B can include one or more ribs 490 that extend from the seals 456A, 456B in order to prevent the seals 456A, 456B from collapsing in on each other, and/or to otherwise strengthen the seals 456A, 456B. Still further, intermittent cuts can be made in the ribs 490 to provide adequate access to the seal gap 474 for the seal pressure source 453B.

This design can provide a very compliant attachment of the seal assembly 450, so that the net forces transmitted between the two bodies being sealed are low. In addition, relatively large dimensional variations in the seal gap 474 can be accommodated with little change in the net forces.

FIG. 5 is a simplified cross-sectional view of a portion of a workpiece 528 and a portion of still another embodiment of a chamber assembly 526 having features of the present invention. In this embodiment, the chamber assembly 526 includes (i) a chamber housing 544, (ii) a chamber pressure source 546, and (iii) a seal assembly 550 that are somewhat similar to the corresponding components described above. Similar to the previous embodiments, the chamber housing 544 cooperates with the workpiece 528 and the seal assembly 550 to define a sealed chamber 538 adjacent to the workpiece 528. Additionally, the chamber pressure source 546 controls a chamber pressure within the sealed chamber 538 so as to minimize any sagging of the workpiece 528 due to the forces of gravity.

In FIG. 5, the chamber housing 544 includes a planar section 566 that is substantially parallel to the workpiece 528, and does not include a flange section like certain previous embodiments. Additionally, in FIG. 5, the seal assembly 550 includes (i) a seal body 553A that seals the chamber housing 544 to the workpiece 528, and (ii) a seal pressure source 553B that is in fluid communication with and that controls a seal pressure of a seal gap 574 in the seal body 553A. In FIG. 5, the seal body 553A is a single seal 556 that defines the seal gap 574.

In this embodiment, the seal assembly 550 also includes a seal inlet 553C that extends into the seal gap 574, and the seal pressure source 553B is in fluid communication with the seal inlet 553C. Stated another way, the seal pressure source 553B is in fluid communication with the seal gap 574 via the seal inlet 553C. In FIG. 5, the seal inlet 553C is defined by a tube that is in fluid communication with the seal gap 574.

Moreover, in this embodiment, the seal 556 includes a first seal contact region 570 that engages the workpiece 528, and a second seal contact region 572 that engages the workpiece 528. Again, in this embodiment, the seal pressure source 553B controls the seal pressure within the seal gap 574 to pull the seal contact regions 570, 572 against the workpiece 528 and to seal the chamber housing 544 to the workpiece 528.

In this embodiment, the seal 556 is a flexible member that is made from rubber or another substantially compliant material. Additionally, in this embodiment, the seal 556 includes (i) a bent section 557A that flexes to allow for movement between the chamber housing 544 and the workpiece 528 and inhibits the transfer of force from the chamber housing 544 to the workpiece 528, and (ii) an inverted “U” shaped section 557B that engages the workpiece 528 and that defines the seal contact regions 570, 572. This design can also provide a very compliant attachment of the seal assembly 550, so that the net forces transmitted between the two bodies being sealed are low.

FIG. 6 is a simplified cross-sectional view of a portion of a workpiece 628 and a portion of still another embodiment of a chamber assembly 626 having features of the present invention. In this embodiment, the chamber assembly 626 includes (i) a chamber housing 644, (ii) a chamber pressure source 646, and (iii) a seal assembly 650 that are somewhat similar to the corresponding components described above. Similar to the previous embodiments, the chamber housing 644 cooperates with the workpiece 628 and the seal assembly 650 to define a sealed chamber 638 adjacent to the workpiece 628. Additionally, the chamber pressure source 646 controls a chamber pressure within the sealed chamber 638 so as to minimize any sagging of the workpiece 628 due to the forces of gravity.

In FIG. 6, the chamber housing 644 includes a planar section 666 that is substantially parallel to the workpiece 628, and does not include a flange section like certain previous embodiments. Additionally, in FIG. 6, the seal assembly 650 includes (i) a seal body 653A that seals the chamber housing 644 to the workpiece 628, and (ii) a seal pressure source 653B that is in fluid communication with and that controls a seal pressure of a seal gap 674 in the seal body 653A. In FIG. 6, the seal body 653A is a single seal 656 that defines the seal gap 674.

In this embodiment, the seal assembly 650 also includes a seal inlet 653C that extends into the seal gap 674, and the seal pressure source 653B is in fluid communication with the seal inlet 653C. In FIG. 6, the seal inlet 653C is defined by a tube that is in fluid communication with the seal gap 674.

Moreover, in this embodiment, the seal 656 includes a first seal contact region 670 that engages the workpiece 628, and a second seal contact region 672 that engages the workpiece 628. Again, in this embodiment, the seal pressure source 653B controls the seal pressure within the seal gap 674 to pull the seal contact regions 670, 672 against the workpiece 628 and to seal the chamber housing 644 to the workpiece 628.

In this embodiment, the seal 656 is a flexible member that is made from rubber or another substantially compliant material. Additionally, in this embodiment, the seal 656 includes (i) a flexible section 657A that flexes and cantilevers away from the chamber housing 644 to allow for movement between the chamber housing 644 and the workpiece 628 and inhibits the transfer of force from the chamber housing 644 to the workpiece 628, and (ii) an inverted “U” shaped section 657B that engages the workpiece 628 and that defines the seal contact regions 670, 672. This design can also provide a very compliant attachment of the seal assembly 650, so that the net forces transmitted between the two bodies being sealed are low.

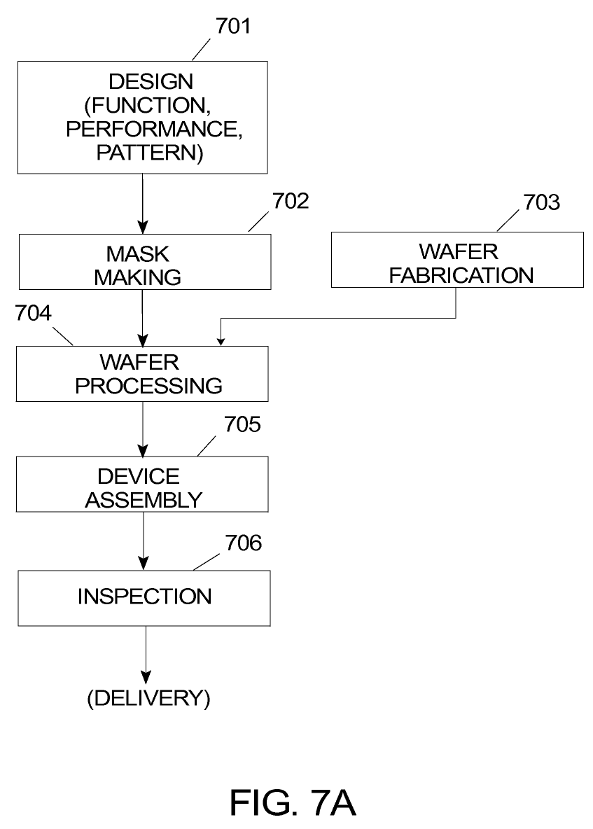

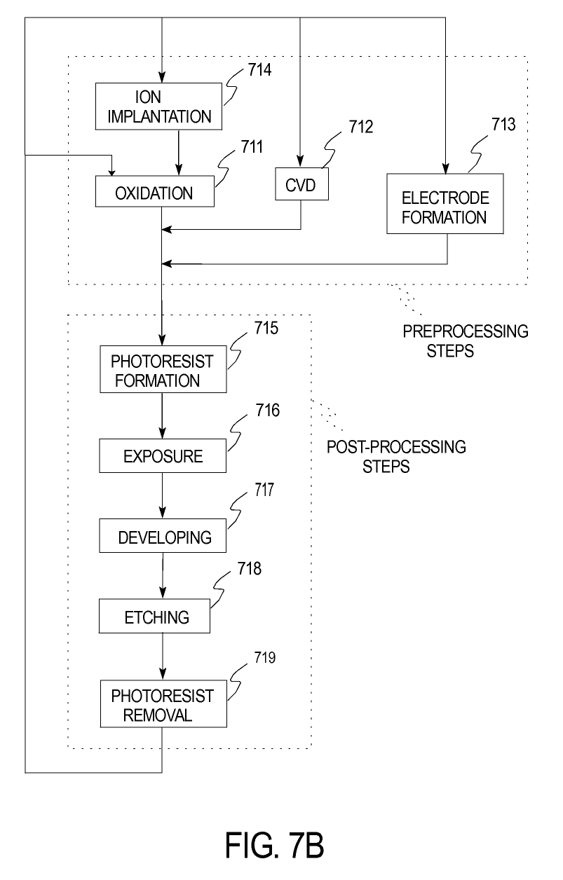

LCD devices or semiconductor devices can be fabricated using the above described systems, by the process shown generally in FIG. 7A. In step 701 the device's function and performance characteristics are designed. Next, in step 702, a mask (reticle) having a pattern is designed according to the previous designing step, and in a parallel step 703 a substrate is made. The mask pattern designed in step 702 is exposed onto the substrate from step 703 in step 704 by a photolithography system described hereinabove in accordance with the present invention. In step 705 the LCD device or semiconductor device is assembled (including the dicing process, bonding process and packaging process), finally, the device is then inspected in step 706.

FIG. 7B illustrates a detailed flowchart example of the above-mentioned step 704 in the case of fabricating LCD devices or semiconductor devices. In FIG. 7B, in step 711 (oxidation step), the substrate surface is oxidized. In step 712 (CVD step), an insulation film is formed on the substrate surface. In step 713 (electrode formation step), electrodes are formed on the substrate by vapor deposition. In step 714 (ion implantation step), ions are implanted in the substrate. The above mentioned steps 711-714 form the preprocessing steps for LCD devices or semiconductor wafers during processing, and selection is made at each step according to processing requirements.

At each stage of processing, when the above-mentioned preprocessing steps have been completed, the following post-processing steps are implemented. During post-processing, first, in step 715 (photoresist formation step), photoresist is applied to a substrate. Next, in step 716 (exposure step), the above-mentioned exposure device is used to transfer the circuit pattern of a mask (reticle) to a substrate. Then in step 717 (developing step), the exposed substrate is developed, and in step 718 (etching step), parts other than residual photoresist (exposed material surface) are removed by etching. In step 719 (photoresist removal step), unnecessary photoresist remaining after etching is removed.

Multiple circuit patterns are formed by repetition of these preprocessing and post-processing steps.

While a number of exemplary aspects and embodiments of a chamber assembly 26 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A chamber assembly for providing a sealed chamber adjacent to a workpiece, the chamber assembly being substantially surrounded by an environment that is at an environmental pressure, the chamber assembly comprising:
a chamber housing that cooperates with the workpiece to define at least a portion of the sealed chamber;
a chamber pressure source for controlling a chamber pressure within the sealed chamber so that the chamber pressure is different than the environmental pressure; and
a seal assembly for sealing the chamber housing to the workpiece, the seal assembly including a first seal contact region and a second seal contact region that cooperate to define a seal gap adjacent to at least one of the chamber housing and the workpiece, and a seal pressure source for controlling a seal pressure within the seal gap so that the seal pressure is different than the chamber pressure and the environmental pressure.

2. The chamber assembly of claim 1 wherein the chamber pressure source controls the chamber pressure to be less than the environmental pressure.

3. The chamber assembly of claim 1 wherein the chamber pressure source controls the chamber pressure to be more than the environmental pressure.

4. The chamber assembly of claim 1 wherein the seal pressure source controls the seal pressure to be less than the chamber pressure and the environmental pressure.

5. The chamber assembly of claim 1 wherein the first seal contact region is spaced apart from the second seal contact region, wherein the seal gap is positioned substantially between the first seal contact region and the second seal contact region, and wherein the first seal contact region substantially encircles the second seal contact region.

6. The chamber assembly of claim 1 wherein the workpiece includes a workpiece surface and wherein the chamber housing includes a cover surface, and wherein the seal assembly extends between the workpiece surface and the cover surface.

7. The chamber assembly of claim 6 wherein the first seal contact region and the second seal contact region cooperate to exert a first force on at least one of the workpiece surface and the cover surface, wherein the seal pressure source generates a second force on the at least one of the workpiece surface and the cover surface, and wherein the first force is approximately equal in magnitude and opposite in direction to the second force.

8. The chamber assembly of claim 1 wherein the seal pressure is controlled so that the net force of the seal assembly on the workpiece is approximately equal to zero.

9. The chamber assembly of claim 1 wherein at least a portion of the chamber housing is substantially transparent.

10. A stage assembly including a stage that supports and moves the workpiece along one or more axes, and the chamber assembly of claim 1.

11. A combination including an LCD mask and the stage assembly of claim 10, wherein the stage supports and moves the LCD mask along one or more axes.

12. An exposure apparatus including an illumination system and the stage assembly of claim 10 that moves the stage relative to the illumination system.

13. A process for manufacturing a device that includes the steps of providing a substrate and forming an image to the substrate with the exposure apparatus of claim 12.

14. A chamber assembly for providing a sealed chamber adjacent to a workpiece, the chamber assembly being substantially surrounded by an environment having an environmental pressure, the chamber assembly comprising:
a chamber housing that cooperates with the workpiece to define at least a portion of the sealed chamber, wherein at least a portion of the chamber housing is substantially transparent;
a chamber pressure source for controlling a chamber pressure within the sealed chamber so that the chamber pressure is less than the environmental pressure; and
a seal assembly for sealing the chamber housing to the workpiece, the seal assembly including (i) a first seal contact region, (ii) a second seal contact region that is spaced apart from the first seal contact region, the seal contact regions cooperating to define a seal gap adjacent to the workpiece, and (iii) a seal pressure source for controlling a seal pressure within the seal gap so that the seal pressure is less than the environmental pressure and the chamber pressure.

15. The chamber assembly of claim 14 wherein the first seal contact region and the second seal contact region cooperate to exert a first force on the workpiece, and wherein the seal pressure source generates a second force on the at least one of the workpiece surface and the cover surface, and wherein the first force is approximately equal in magnitude and opposite in direction to the second force.

16. The chamber assembly of claim 14 wherein the seal pressure is controlled so that the net force of the seal assembly on the workpiece is approximately equal to zero.

17. A combination including a stage assembly and an LCD mask, the stage assembly including a stage that supports and moves the LCD mask along one or more axes, and the chamber assembly of claim 14.

18. An exposure apparatus including an illumination system, and a stage that supports and moves the workpiece and the chamber assembly of claim 14 along one or more axes.

19. A method for providing a sealed chamber adjacent to a workpiece, the sealed chamber being substantially surrounded by an environment having an environmental pressure, the method comprising the steps of:
providing a chamber housing that cooperates with the workpiece to define at least a portion of the sealed chamber;
controlling a chamber pressure within the sealed chamber with a chamber pressure source, the chamber pressure being different than the environmental pressure; and
sealing the chamber housing to the workpiece with a seal assembly, the seal assembly including (i) a first seal contact region, (ii) a second seal contact region that cooperates with the first seal contact region to define a seal gap adjacent to at least one of the chamber housing and the workpiece, and (iii) a seal pressure source that controls a seal pressure within the seal gap to be different than the chamber pressure and the environmental pressure.

20. The method of claim 19 wherein the step of controlling the chamber pressure includes the step of controlling the chamber pressure with the chamber pressure source to be less than the environmental pressure.

21. The method of claim 19 wherein the step of sealing includes the step of controlling the seal pressure to be less than the chamber pressure and the environmental pressure.

22. The method of claim 19 wherein the step of sealing includes the step of controlling the seal pressure to be more than the chamber pressure and the environmental pressure.

23. The method of claim 19 wherein the steps of sealing includes the step of controlling the seal pressure so that a net force of the seal assembly on the workpiece surface is approximately equal to zero.

24. A method for making a combination, the method comprising the steps of providing an LCD mask, moving the LCD mask along one or more axes with a stage that retains the LCD mask, and providing a sealed chamber adjacent to the LCD mask by the method of claim 19.

25. A method for making an exposure apparatus for transferring an image to a workpiece, the method comprising the steps of providing an optical assembly, moving the workpiece with a stage that retains the workpiece, and providing a sealed chamber adjacent to the workpiece by the method of claim 19.
